(19) United States
(12) Patent Application Publication
(10) Pub. No.: US 2002/0198761 A1
(43) Pub. Date: Dec. 26, 2002

(54) System and method for identifying a market by projecting demand and identifying supply

(75) Inventors: Patrick G. Ryan, Chicago, IL (US); David P. Jacobs, Chicago, IL (US)

Correspondence Address: SIDLEY AUSTIN BROWN & WOOD LLP, 717 NORTH HARWOOD, SUITE 3400, DALLAS, TX, 75201, US

(73) Assignee: FIRST LOOK NETWORKS, L.L.C.

(21) Appl. No.: 09/878,707

(22) Filed: Jun. 11, 2001

(51) Int. Cl. G06F 17/60

(52) U.S. Cl. 705/10

(57) ABSTRACT

A market for used vehicles is identified for a particular vehicle category. A group of dealers are selected who have a high likelihood of buying units of the products. To identify a market, inventory data is collected from each of a group of dealers within a region on a recurring basis. A dealer profile specifying the business rules for managing the inventory is obtained or produced for each dealer. A supply of products is determined by collecting inventory data from suppliers, such as automobile leasing companies and dealers with surplus inventory. The demand for products is determined by comparison of the dealer profile for each vehicle category to the actual inventory for the corresponding vehicle category and/or to the sales history for the product. The data for each product unit is expanded by reference to third party data bases by use of the vehicle identification number. The data thus collected and produced is aggregated for all of the dealers such that there is a composite representation of the demand for each vehicle category. For each vehicle category having a substantive supply and demand, a market is identified. Participants for this market are those dealers who have a significant demand for the products in the market category. The dealers are invited to a market which is called for the particular vehicle category. Multiple vehicle categories may be combined in one market. As a result, a highly efficient market is organized that is directed to one or more specific vehicle categories that are of high interest to a specified group of dealers and suppliers.

### TECHNICAL FIELD OF THE INVENTION

The present invention pertains in general to the collection and analysis of marketing information and in particularly to the identification of a market for a specific product and participants for that market.

### BACKGROUND OF THE INVENTION

The selling and reselling of automobiles in the United States is a very large industry both in terms of numbers of transactions and dollar volume. New vehicles are sold by franchised automobile dealers who purchase the vehicles directly from the manufacturers. These dealers also sell used vehicles and the purchase and sale of used vehicles is a large product market. There is no single source of supply for used vehicles like that of new vehicles, so the dealers must obtain their inventory of used vehicles from various sources. One source of such used vehicles is the trade-in of vehicles for purchases of new automobiles. However, such vehicles are not necessarily the types of vehicles that the dealer wishes to have in its used car inventory. Therefore, the dealer must obtain a major part of its inventory of used vehicles from other sources. These other sources include large volume wholesale markets and direct purchases from other dealers.

An automobile dealer generally has a desired inventory for its used vehicle supply. The dealer wants to have the vehicles that can be most readily sold and which have the greatest profit margin. One restriction on the purchase and sale of used vehicles is that the dealing most often must be done in a particular geographic region because the transportation of vehicles is expensive and many dealers are hesitant to travel frequently to auctions at distant locations.

Wholesale auctions are a primary means for the marketing of used vehicles. Such auctions can involve thousands of vehicles, but a dealer is often only interested in purchasing a very small percentage of the vehicles that are being offered for sale, thus substantial time can be wasted. Dealers can also use the wholesale auctions to dispose of vehicle inventory which has not been sold within an expected period of time. Thus, a dealer typically both buys and sells at a wholesale market to maintain its desired inventory of used vehicles.

The existing system for the distribution of used vehicles is primarily supply driven. The suppliers of used vehicles “push” their inventory of vehicles to the buyers. This means that information about available used vehicles is broadcast or distributed to potential purchasers with little regard to the actual products needed at that time by each potential purchaser. As a result, the purchasers must each sort through the mass of received information to locate the specific products which are of interest to the particular purchaser. This supply driven system is expensive, inefficient and time consuming for both the suppliers and purchasers of used vehicles.

There are many inefficiencies in the working of the existing market for used vehicles. Due to the wide range in the makes, models and options available for vehicles, it is often challenging for a dealer to obtain the exact types of vehicles in the quantities required for its inventory. Large wholesale markets can increase the chance that a buyer can obtain the desired vehicles, but the larger markets consume greater amounts of time and are thus counterproductive to efficiency in the marketplace. Thus, there exists a need for an improved market system for use in particular with used automobiles, but which is also applicable to other products which are inventoried and sold in a similar manner.

### SUMMARY OF THE INVENTION

A selected embodiment of the present invention is a method for creating a market for a particular type of product. The products are purchased and sold by dealers and are also provided by suppliers. A dealer may also be a supplier. The process includes a first step of collecting inventory information on a recurring basis for each of a plurality of product classes from each of a plurality of the dealers. A current demand for one or more of the products classes is determined for each dealer based on the dealer inventory information or a sales history of the dealer where the sales history is derived from the dealer sales information. The demands for each of the dealers are aggregated for all of the product classes. A determination is made from the suppliers of the products as to a supply of units available for sale for each of a plurality of the product classes. For each of the product classes a reference is made to predetermined supply and demand volumes for determining the ones of the product classes which have sufficient supply and demand to constitute a viable market. A market is designated for each of the product classes determined to have the sufficient supply and demand volume. For each market, the units of the supply of the product classes are offered to the dealers who have demand for the product class in the market. The market can be conducted in person, through electronic communication such as the Internet, or through a combination of electronic and in-person interaction.

A multi-product type market can be created by combining a plurality of individual product class markets which have at least a minimum number of potential buyers.

### BRIEF DESCRIPTION OF THE DRAWINGS

For a more complete understanding of the present invention and the advantages thereof, reference is now made to the following description taken in conjunction with the accompanying drawings in which:

FIG. 1 is a schematic illustration of a communication system for interconnecting a group of dealers and a group of lease companies with a market maker system,

FIGS. 2A and 2B are a flow diagram representing a sequence of steps in accordance with the present invention for collecting demand and supply information and identifying specific markets related to specific product types,

FIGS. 3A and 3B are a flow diagram representing an alternate series of steps in accordance with the present invention for collecting supply and demand information for various product types and identifying specific markets of these product types,

FIGS. 4-7 are dealer inventory and sales data for multiple product types,

FIGS. 8-11 are charts illustrating inventories of product types available for sale from lease companies,

FIG. 12 is a chart of aggregated dealer demand,

FIG. 13 is a chart of aggregated supply, and

FIG. 14 is a chart of identified markets with corresponding dealers and suppliers, and

FIG. 15 is an illustration of a multi-product market.

### DETAILED DESCRIPTION

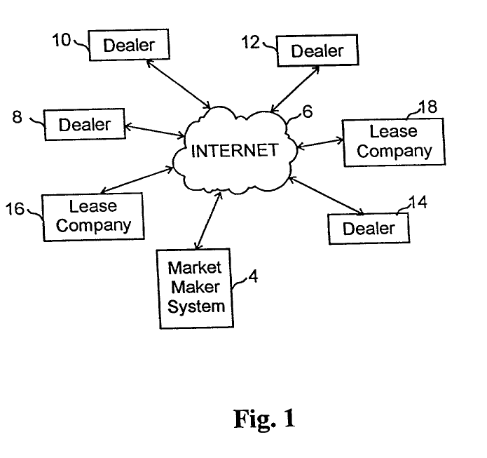

The present invention is directed to a system for creating markets for products to be purchased by a group of dealers, which are typically within a given geographical area. The present invention is described in reference to the purchase and sale of used vehicles, but it is also applicable to other products and services which are traded in a similar manner. Referring to FIG. 1, there is shown a market maker system 4 in accordance with the present invention which works through a network 6 for intercommunication with multiple entities. The network 6 can be, for example, the public telephone system or the Internet In this illustration a plurality of automobile dealers 8, 10, 12 and 14 are connected for communication through the network 6 with the market maker system 4. In addition, a plurality of automobile lease companies 16 and 18 are also connected for communication with the market maker system 4.

Service marks for representing the market maker system 4 are “Network Market Maker” and “NM².”

Each of the dealers shown in FIG. 1 has a computerized management system, which is often termed a dealer management system (DMS) in the automotive industry. This system tracks the dealer's purchase and sale of vehicles and maintains an inventory listing of all vehicles in the dealer's stock. The inventory information identifies each specific vehicle with associated information such as purchase price, purchase date, and the length of time the vehicle has been in inventory. The lease companies 16 and 18 lease vehicles, and at the end of the lease period many of the vehicles are returned to the lease companies which then make them available for sale at wholesale to dealers. The lease companies may be “captives” of vehicle manufacturers, and therefore sell only specific makes, or a lease company may be independent and offer vehicles from multiple manufacturers. Each of these lease companies has a computer system that maintains an inventory listing of the vehicles that it has for sale. This inventory listing has essential information related to the vehicle.

An inventory data base of each dealer is a listing of the used vehicles in the dealer's inventory together with specific information identifying each vehicle and having information about each vehicle. The information collected about each vehicle in the inventory data base, in a representative environment, is as follows:

| | |
|---|---|
| 1. | Make of vehicle |
| 2. | Model of vehicle |
| 3. | Manufacturer of vehicle |
| 4. | Year of manufacture |
| 5. | Vehicle Identification Number (VIN) |
| 6. | List of options |
| 7. | Purchase price |
| 8. | Date entered into inventory |
| 9. | Mileage |
| 10. | Condition |
| 11. | Repair, service and make-ready costs |

Each dealer has a set of formal and/or informal business rules which define the way in which the dealer manages his inventory of used vehicles. This is referred to herein as a “dealer profile.” A dealer develops the profile in order to optimize the profitability of his used car transactions. Dealers typically design the profile based upon their experience in the industry. Such profiles may vary from season to season due to the fluctuation in demand for certain types of vehicles. One aspect of the dealer profile is the number of vehicles that are maintained in stock. This could be limited by the space available to the dealer, financing available to maintain the inventory or by the size of inventory needed to attract customers and close immediate sales. The makeup of the vehicle stock is an important aspect in defining the type of inventory maintained by the dealer. The dealer must maintain a sufficient stock of vehicles that are different to meet the varying requirements of consumers. However, the dealer cannot be so specialized as to maintain vehicles in inventory which may have limited appeal and may remain in inventory for an extended period of time. Thus, the dealers are very careful to maintain what they consider to be an optimum composition of the inventory. This includes quickly restoring inventory after sales and disposing of hard to sell vehicles from the inventory.

A still further aspect of inventory management is the length of time that a vehicle is held in inventory for retail sale. When a vehicle remains in inventory for an extended time, the value of the vehicle is reduced due to depreciation and the expense of the vehicle to the dealer increases due to interest cost. A dealer must have a rapid turnover of inventory in order to sell as many vehicles as possible. The dealer's objective is to sell each vehicle in a retail transaction, but if the vehicle remains in inventory for an extended period of time, it becomes a liability and it is in the dealer's best interest to remove it from inventory as soon as possible. After a vehicle has been in the inventory for more than a predetermined period of time, the dealer generally prefers to dispose of the vehicle at a wholesale price, rather than retaining it for expected sale in the future at retail.

A vehicle category (also referred to as a product class) is defined as a related group of vehicle types, rather than a specific vehicle. One vehicle category can be, for example, F-150 Ford pickup trucks which are less than 3 years old (late model). Although there may be variations within this vehicle category (product class), the vehicles are sufficiently similar for the purpose of marketing and inventory management. The principal factors for defining a category of vehicles are the (1) make, (2) model, and (3) age bracket (either late model, which is the last three years, or intermediate model, which is three to five years old). For example, a Honda Prelude which is one year old is in a different category from a Honda Prelude which is four years old.

For purposes of describing an example for the present invention, the following vehicle categories (classes) are used:

| Category | Year | Make | Model |
|---|---|---|---|
| A. | 1998-2001 | Mazda | 626 |
| B. | 1997-2000 | Toyota | Corolla |
| C. | 1996-1999 | GMC | Jimmy |
| D. | 1998-2001 | Ford | Taurus |
| E. | 1996-1999 | Oldsmobile | Aurora |
| F. | 1998-2001 | Chevrolet | Corsica |
| G. | 1997-2000 | Pontiac | Grand Prix |
| H. | 1996-1999 | Honda | Prelude |
| I. | 1996-1999 | Isuzu | Rodeo |
| J. | 1998-2001 | Isuzu | Trooper |
| K. | 1998-2001 | Toyota | Avalon |
| L. | 1998-2001 | Honda | Civic |
| M. | 1998-2001 | Nissan | Sentra |
| N. | 1998-2001 | Pontiac | Grand Am |
| O. | 1997-2000 | Jeep | Grand Cherokee |
| P. | 1997-2000 | Nissan | Maxima |

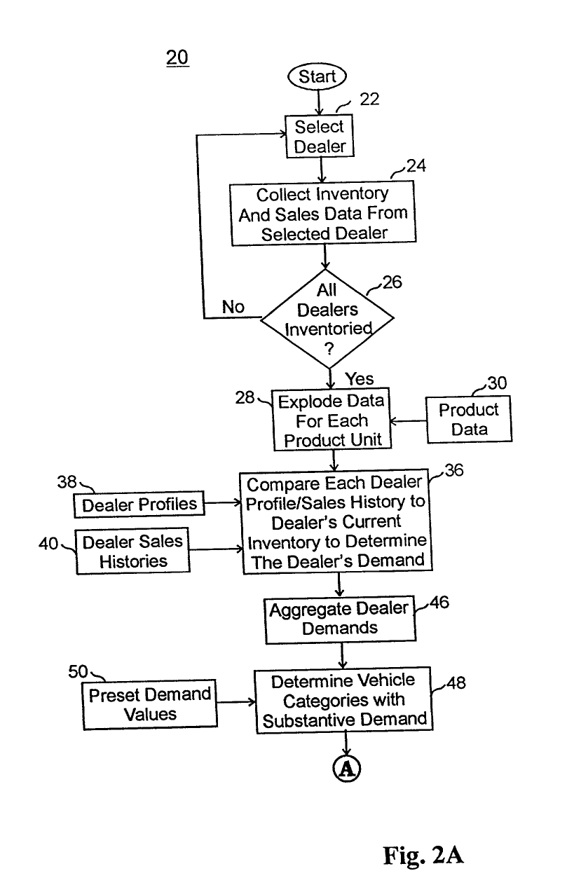

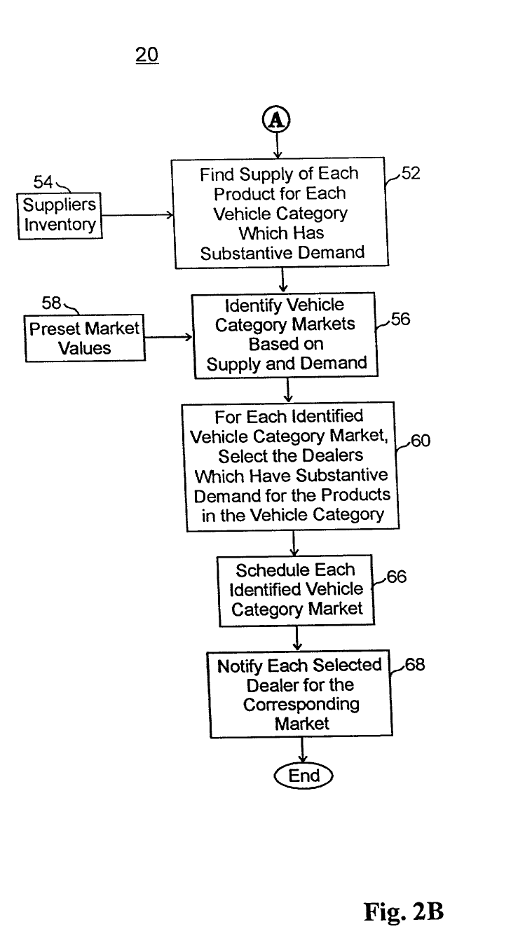

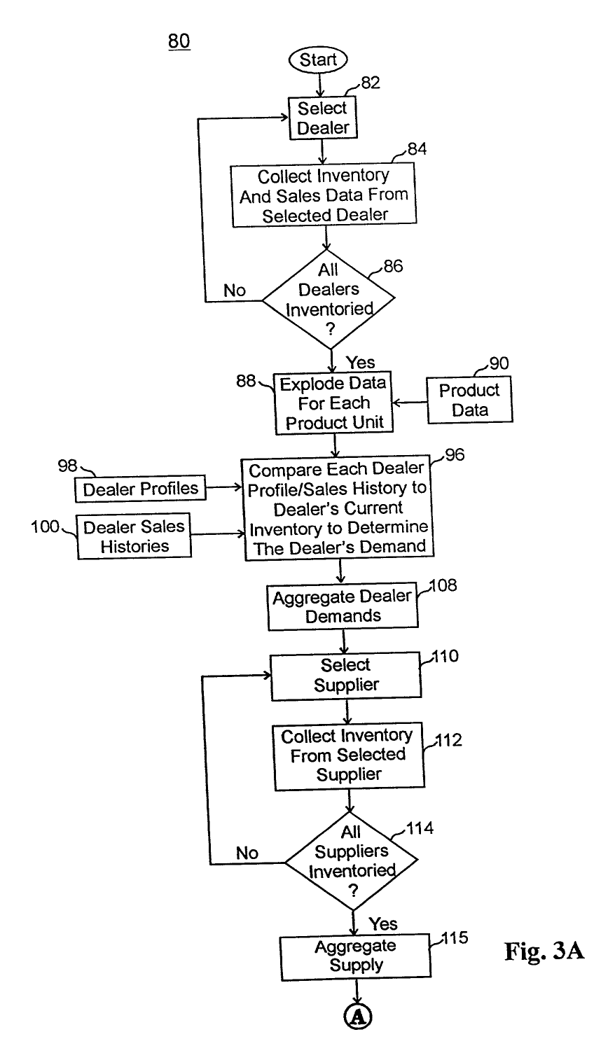

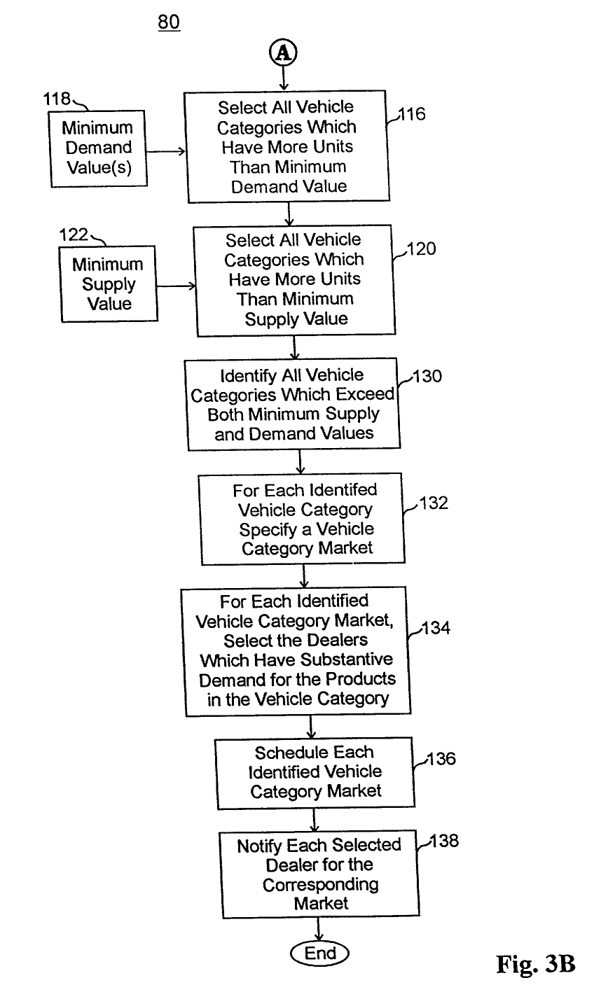

Briefly, in accordance with the present invention, market maker system 4 collects sales and inventory information periodically from each of the dealers and, based on an analysis of this information, it estimates the demand for each vehicle category for each of the dealers. Market maker system 4 also collects inventory information from each of the lease companies to determine the supply of each category of vehicle from these companies. In certain cases, the dealers may also have vehicles for sale at wholesale, and in these cases the dealers can also be suppliers. Market maker system 4 aggregates the demand for vehicles from the dealers and also aggregates the supply of vehicles from the lease companies and also those dealers who have vehicles for sale. The quantity of each category of vehicle for both supply and demand is compared to a pre-set threshold number of units to determine if a viable market exists for that particular vehicle category. Such a comparison is made for each category for which information is collected. For those vehicle categories which have both substantive supply and demand, a market is identified for that vehicle category. The dealers who have demand for that vehicle category are identified and then invited to participate in a market for the vehicles of that category. A supply of vehicles from the lease companies, and perhaps some dealers, is established such that the vehicles can be sold through the market maker system 4 to the dealers. For greater efficiency, a group of such markets can be combined so that a market of several hundred vehicles can be held at one time. A more detailed description of the present invention is provided in the flow diagrams shown in FIGS. 2A, 2B and FIGS. 3A, 3B, the other figures, and in the accompanying text.

The present invention creates a demand driven market in which the demand for vehicles leads to the consummation of product sales, wherein the demand driven market is in contrast to conventional supply driven markets.

FIGS. 2A-2B represent a first embodiment of the present invention wherein supply information is collected based on previously determined demand. FIGS. 3A-3B represent an embodiment in which comprehensive data is collected for both demand and supply.

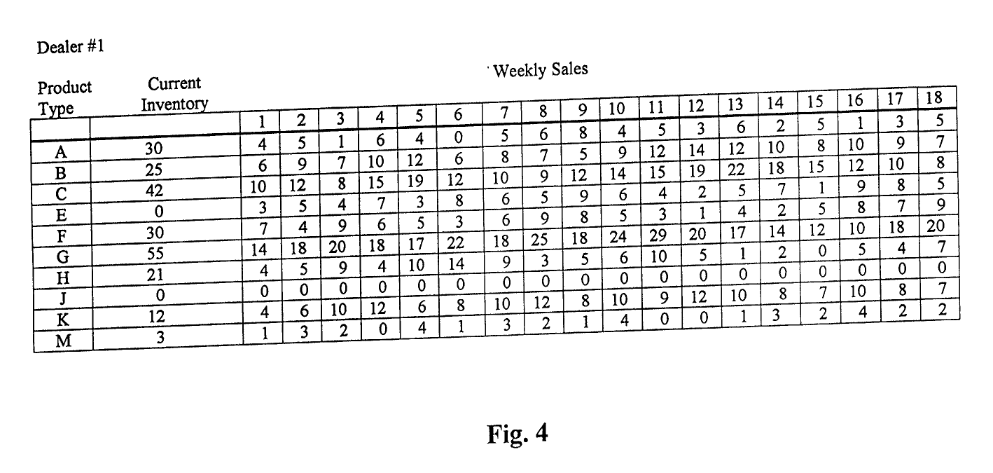

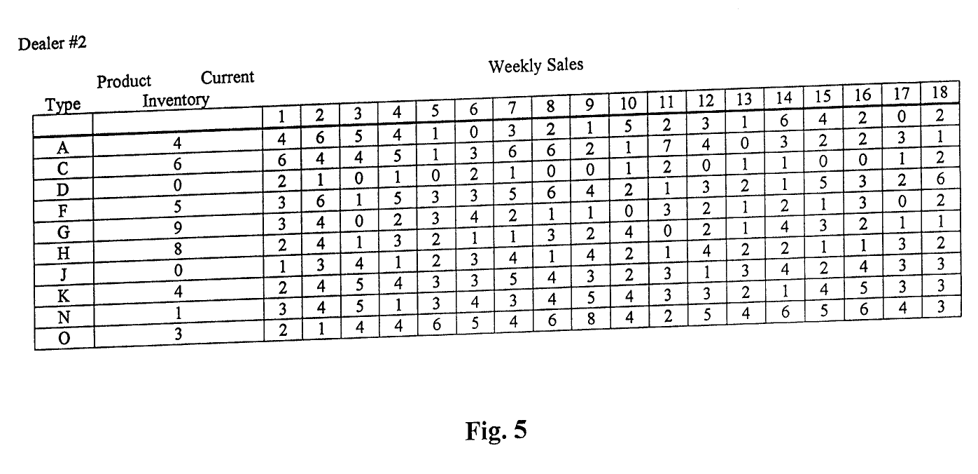

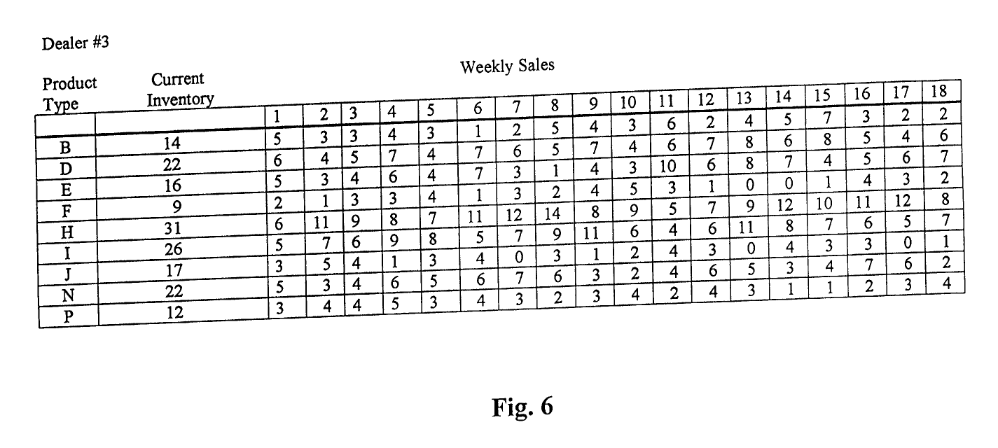

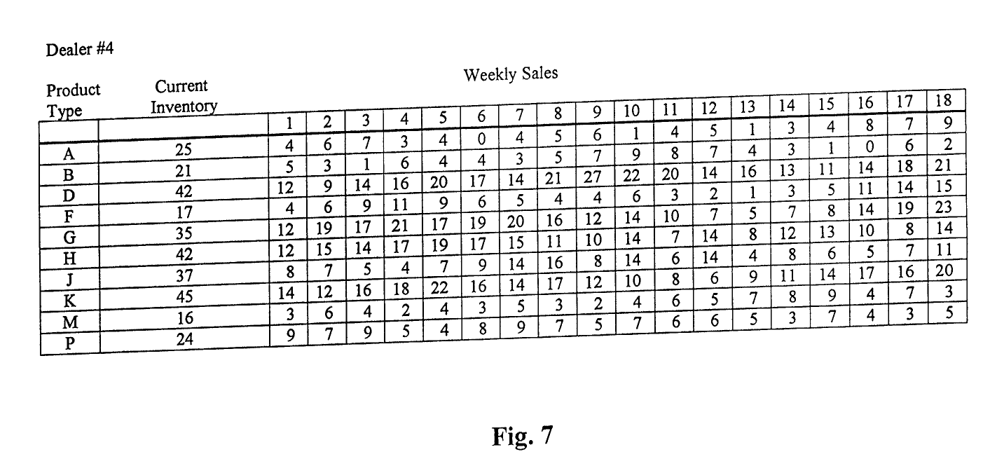

Referring now to FIG. 2A for process 20, following the start, in block 22 a dealer is selected from among a group of dealers who have agreed to participate in the marketing arrangement organized and directed by the market maker system 4. After selection of a dealer, at step 24, inventory and sales data is collected from the selected dealer. The collected information is for each vehicle in the dealer's inventory. This is, for example, the inventory and sales data for dealer #1 shown generally in FIG. 4. Continuing to step 26, an inquiry is made to determine if all dealers have been inventoried. If not, a next dealer is selected at step 22 and the process of collecting inventory and sales data is continued until all dealers have been inventoried. Sales information for dealers #2, 3 and 4 are shown respectively in FIGS. 5, 6 and 7. A preferred cycle has a weekly collection of information. This information includes both inventory and sales. As shown in FIG. 4, dealer #1, for a particular week, has the inventory of cars shown for product categories A, B, C, E, F, G, H, J, K and M. A history is maintained of weekly sales with information being obtained each week. As shown in FIG. 4, a history of sales for the last 18 weeks is maintained. However, weekly sales information for a long period of time may also be maintained and analyzed.

When the inventory and sales information has been collected from all dealers, entry is made to block 28 in which the data for each product unit is “exploded.” This means that the full information about each product unit (vehicle) is collected, and if necessary corrected. The dealer inventory identifies each vehicle by at least the vehicle identification number, but often the dealer information is incomplete or inaccurate. Other sources of data, such as product data from block 30, can be referenced to provide the additional information to fully characterize each particular vehicle. Complete information of this type is necessary for marketing of the vehicle. Such product data is available from publicly accessible data bases.

At step 36 a comparison is made between a dealer profile and/or the sales history of the dealer for each particular vehicle category in comparison to the current inventory of the dealer to determine the particular dealer's demand for each category of vehicle. This analysis is supported by dealer profiles 38 which have been previously collected or disclosed for each dealer, as well as the sales histories 40 for each dealer which are compiled based on the sales history data that is collected from each dealer.

A particular analytical process for determining such a projected demand based on the collected information is as follows. A dealer may define his desired used vehicle profile as a listing of vehicle categories and a number of days supply for each category. Therefore, the number of vehicles needed to be in inventory for each category is a function of the rate of sale and the number of days supply. For example, if a dealer wants to have a three week supply of vehicles in a particular category and he sells an average of four of these vehicles per week, he would need an inventory of twelve of the vehicles.

An example of a dealer profile is:

| Vehicle Category | Days Supply | Sales Rate (per week) | No. of Vehicles |
|---|---|---|---|
| A | 21 | 3 | 9 |
| B | 28 | 1 | 4 |
| C | 14 | 2 | 4 |
| E | 21 | 4 | 12 |
| F | 28 | 3 | 12 |
| G | 14 | 4 | 8 |
| H | 14 | 2 | 4 |
| J | 28 | 6 | 24 |
| K | 14 | 5 | 10 |
| M | 35 | 3 | 21 |

To determine demand, the dealers preferred inventory for a vehicle category is compared to the actual inventory. If the preferred number of vehicles exceeds the actual inventory, the dealer demand is the difference. Other algorithms may also be used to determine a dealer's demand. The dealer profile above may be defined by the dealer or it may be determined by analyzing the sales history of the dealer.

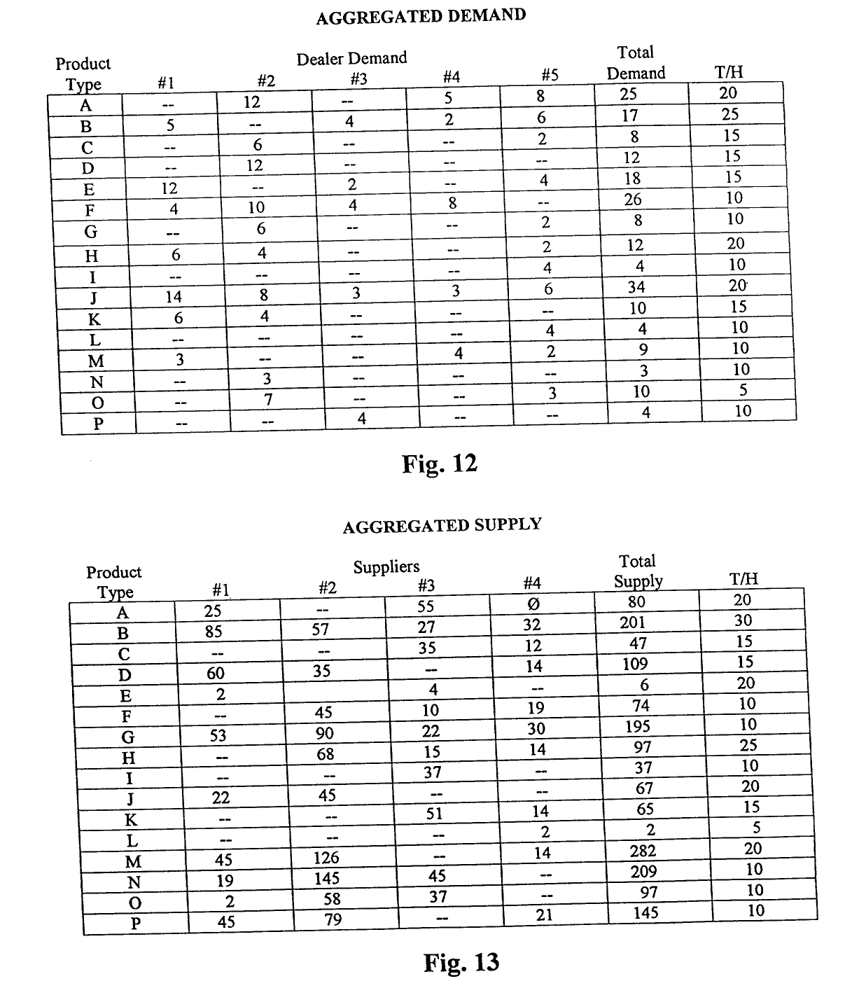

After the projected demand of each dealer has been determined at block 36, the dealer demands are aggregated in block 46 for the relevant market, typically for a specific geographical region. See FIG. 12 for an example of aggregated demand. This figure lists all of the product categories and the projected demand for each dealer for each product type. The demands for each product type are summed in the Total Demand column. To the right of the Total Demand there is a listing of the threshold (T/H) values for each product type which must be met in the aggregate demand in order to establish a market based on the supply of units for that product category.

The next step in the process 20 is to determine the vehicle categories which have substantive demand, that is, sufficiently large to justify holding a market. This is performed in step 48 based on pre-set demand values received from block 50. There must be at least a minimum number of units in demand for a particular vehicle category before it is worthwhile to organize a market for the product in that category. The minimum number of units may vary by vehicle category. For example, a minimum volume for the vehicle category representing late model Ford F-150 pickup trucks may be 5 units.

A market for a vehicle category (product class) also requires a minimum number of buyers, for example, at least two buyers.

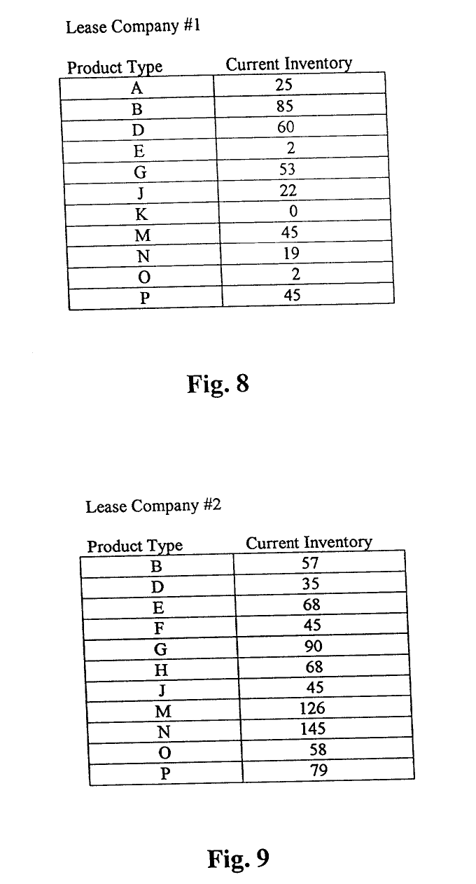

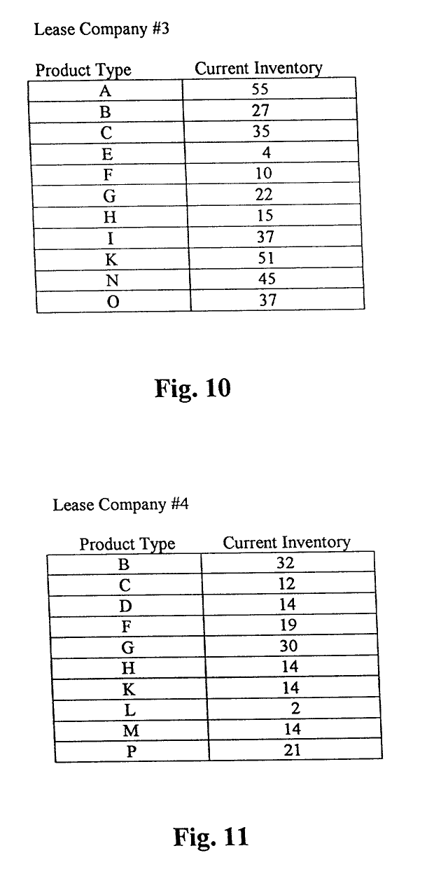

Continuing the process 20 description at FIG. 2B, for each vehicle category which has been determined to have substantive demand, at block 52 the available supply for each of these vehicle categories is determined by reference to the suppliers' inventory from block 54. The suppliers' inventory from block 54 is determined by accessing each of the lease companies such as 16 and 18 shown in FIG. 1, to determine the supply of the vehicles for each category of interest. The inventories of the dealers are also checked for vehicles which are offered for sale at wholesale. This is a data pull operation for obtaining the supply information. The information concerning the supply of vehicles is pulled from suppliers as shown in FIGS. 8, 9, 10 and 11. The market maker system 4 extracts this information from a computer system that has a data storage of this information for each lease company. The aggregated supply is shown in FIG. 13 for each product category. The supply of each product category for each supplier is shown and the total supply (aggregation) is the sum of the supply from each of the suppliers. To the right of the Total Supply column there is a threshold (T/H) listing of minimum units required to establish a market on the supply side.

In block 56, reference is made to a set of pre-set market values in block 58 to determine if the demand and the supply for each product type is adequate to support a market for that particular product type. Continuing with the above example for a specific product type, a reasonable market for late model Ford pickup trucks should have a supply of at least the number of units of demand. The minimum product units for supply and demand may not be the same for a particular vehicle category. For the vehicle categories which have a number of units in both supply and demand which exceed the minimum threshold values, a vehicle category market is identified.

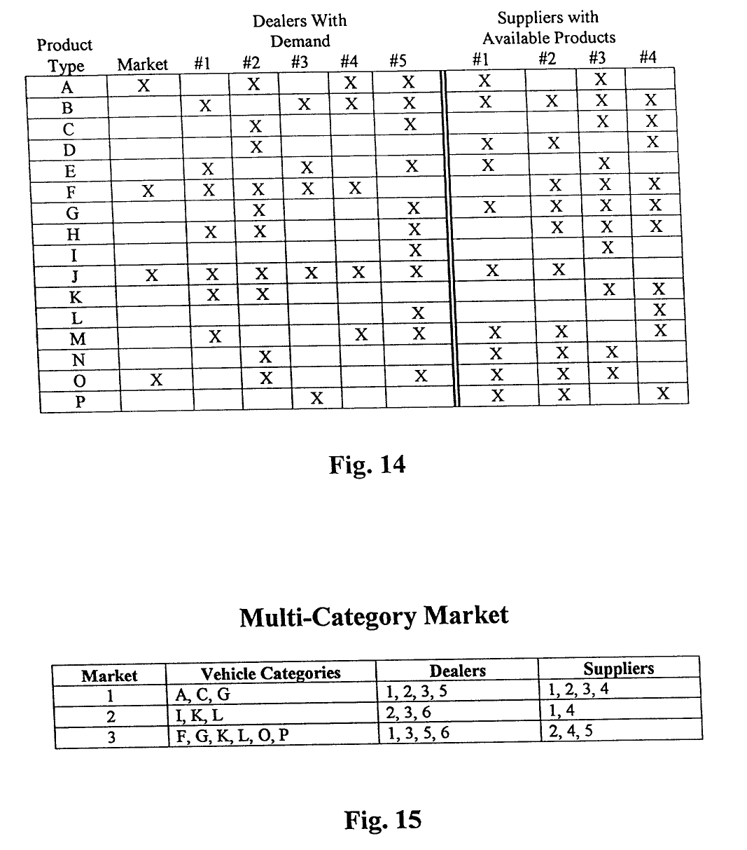

FIG. 14 illustrates a chart of identified markets with corresponding dealers and suppliers for multiple vehicle categories.

Continuing to block 60, an identification is made for each of the dealers which have a substantive demand for the products in each of the identified category markets. This is done with respect to a minimum reference number.

The identification of specific markets is shown in FIG. 14. An “X” is shown in each column for the product type where there is demand by the dealers and supply available from the lease companies. However, a market is not established for each product for which there is both demand and supply. The threshold values must be met for both supply and demand before a market is established. Referring to FIG. 14, as well as to FIGS. 12 and 13, it can be seen that the minimum thresholds are met and markets are established for product types A, F, J and O. Even though there is both supply and demand for other product types, the others fail for not meeting at least one of the threshold requirements. There is also a requirement that there be at least two buyers in order for any market to be established. This requirement is also met for the four identified product type categories for which markets have been determined.

Next, in block 66, a market is scheduled for each vehicle category which has an identified market. At block 68, each dealer having demand for the products in a market vehicle category is identified and provided with specific information about the market of that product. This identification includes the specific units of product to be sold at the market and the associated product information.

At the selected time, the market is held for the product in a selected vehicle category. This can be either through an online auction sale, a physical meeting at a selected location or a combination of both. At the market, the market maker system 4 can offer the supply of product units for sale with minimum sales prices (reserves) set in advance by the suppliers of the products. The dealers can then purchase the products based on an auction or other sales procedure.

A group of selected vehicle categories can be combined into a multi-category market, such as shown in FIG. 15. A larger market, beyond one category, can have greater efficiency and productivity for the dealers and suppliers and can be held at a lower cost per category. The data shown in FIG. 15 is a new data set from that previously described in reference to the earlier figures. In this example, a market “1” is established for vehicle categories A, C and G which involve the identified dealers and suppliers. This market will be held at one time with the product offerings in these three categories. Likewise, the markets “2” and “3” will be held at separate times with the vehicle categories, dealers and suppliers as shown in this figure.

An alternative process 80 in accordance with the present invention is described in a flow diagram shown in FIGS. 3A and 3B. This process is much like process 20 shown in reference to FIGS. 2A and 2B, but with certain variations. Following start, entry is made to block 82 to select a first dealer. Continuing to block 84, inventory and sales data is collected from the selected dealer, in the same manner as described above. At question block 86, a determination is made if all the dealers have been inventoried. If not, return is made to block 82.

When the inventories and sales histories of used vehicles have been collected from all of the dealers, entry is made to block 88 for expansion of the data for all the identified product units based upon information received from product data in block 90. The dealer information is collected as shown in FIGS. 4, 5, 6 and 7. The supply information is collected from the lease companies, and any possible dealers, such as shown in FIGS. 8, 9, 10 and 11.

In block 96, a dealer demand is determined by analysis of dealer profiles from block 98 and dealer sales histories from block 100 as described previously in reference to FIGS. 2A and 2B. This demand analysis can be performed as described above in reference to FIGS. 2A and 2B. After the demands for each vehicle category have been calculated for each dealer, these demands are aggregated in block 108 for a selected marketing region.

At step 110, a first of the suppliers, such as the lease companies 16 and 18 shown in FIG. 1, is identified. At block 112 the inventory of products is collected from the selected supplier. At block 114 an inquiry is made to determine if the inventories have been collected from all suppliers. If not, return is made to block 110 to select a new supplier and repeat the process. When inventories have been collected from all suppliers, the yes exist is taken from block 114 to block 115 in which the supply for each vehicle category is aggregated for all of the suppliers. This produces a listing of the total supply within the given market region for each vehicle category. See FIG. 13 for a chart of aggregated supply.

Following block 115, entry is made to block 116, which is shown in FIG. 3B. In this block the demand for each vehicle category is compared to a minimum demand value received from block 118. Each vehicle category which has a demand that exceeds a corresponding minimum demand value is selected. Continuing to block 120, the supply for each vehicle category is compared to a respective set of minimum supply values which are provided from block 122. The vehicle categories which have at least a number of units greater than the minimum supply values are selected. As an example, a minimum demand and supply may be ten units for a particular vehicle category.

In block 130 the vehicle categories which have unit quantities that meets both the minimum supply and demand values are identified. Next, at block 132, a market is identified for each of the vehicle categories which have been identified in block 130.

At block 134, for each identified vehicle category market, the dealers are selected which have substantive demand for the products of that vehicle category market. Continuing to block 136, a vehicle category market is scheduled for each of the identified vehicle category markets. At block 138 each selected dealer who has substantive demand for the products of a vehicle category market is notified of the existence and the scheduling of the market for that vehicle category. The process is completed at the end block and then repeated as needed. As described above, multiple vehicle categories may be offered in one market meeting.

Dealers other than those having specific demand may also be notified so that they may attend the vehicle market if interested.

Although several embodiments of the invention have been illustrated in the accompanying drawings and described in the foregoing Detailed Description, it will be understood that the invention is not limited to the embodiments disclosed, but is capable of numerous rearrangements, modifications.

What is claimed is:

1. A computer-implemented method for marketing products which are purchased and sold by dealers and are provided by suppliers, comprising the steps of:
collecting inventory information on a recurring basis for each of a plurality of product classes from each of a plurality of said dealers,
for each said dealer, determining a current demand for one or more of said product classes based on said dealer inventory information and an inventory profile of said dealer,
aggregating said demands respectively for said product classes,
for each of said product classes, comparing the corresponding demands to a threshold set of values for determining the ones of said product classes which have said demand exceeding said threshold values,
obtaining from said suppliers information identifying a supply of said products available for sale for each of said determined product classes,
designating a market for each of said determined ones of said product classes, and
for each said market, notifying the ones of said dealers who have a demand for the product class of the market.

2. A computer-implemented method for marketing products as recited in claim 1 further including a step of comparing the supply for each said product class to a respective threshold value and designating a market for only those product classes which exceed both the supply and demand threshold values.

3. A computer-implemented method for marketing products as recited in claim 1 wherein said steps of collecting, determining, aggregating, comparing, obtaining and designating define a plurality of markets for said product classes.

4. A computer-implemented method for marketing products as recited in claim 1 including a step of offering the units of said supply of products for each said designated market to the dealers who have demand for the corresponding product class.

5. A computer-implemented method for marketing products as recited in claim 1 wherein said inventory profile is defined by the corresponding dealer.

6. A computer-implemented method for marketing products as recited in claim 1 wherein said inventory profile is based on a sales history of the corresponding dealer.

7. A computer-implemented method for marketing products as recited in claim 1 wherein said step of collecting inventory information is performed on a periodic time basis.

8. A computer-implemented method for marketing products as recited in claim 1 wherein said suppliers include dealers who have products in inventory which the dealer has deemed to be for sale at wholesale.

9. A computer-implemented method for marketing products as recited in claim 1 wherein said products are used automobiles.

10. A computer-implemented method for marketing products as recited in claim 1 wherein said suppliers include automobile lease companies.

11. A computer-implemented method for marketing products which are purchased and sold by dealers and are provided by suppliers, comprising the steps of:
collecting inventory information on a recurring basis for each of a plurality of product classes from each of a plurality of said dealers,
collecting supply information from said suppliers for a plurality of said product classes,
for each said dealer, determining a current demand for one or more of said product classes based on said dealer inventory information and an inventory profile of said dealer,
aggregating said demands respectively for said product classes,
for each of said product classes, comparing the corresponding supply and demand to a threshold set of values for determining the ones of said product classes which have said supply and said demand exceeding said threshold values,
designating a market for each of said determined ones of said product classes, and
for each said market, notifying the ones of said dealers who have said demand for the product class of the market.

12. A computer-implemented method for marketing products as recited in claim 11 wherein said steps of collecting, determining, aggregating, comparing, obtaining and designating define a plurality of markets for said product classes.

13. A computer-implemented method for marketing products as recited in claim 11 including a step of offering the units of said supply of products for each said designated market to the dealers who have demand for the corresponding product class.

14. A computer-implemented method for marketing products as recited in claim 11 wherein said inventory profile is defined by the corresponding dealer.

15. A computer-implemented method for marketing products as recited in claim 11 wherein said inventory profile is based on a sales history of the corresponding dealer.

16. A computer-implemented method for marketing products as recited in claim 11 wherein said suppliers include dealers who have products in inventory which the dealer has deemed to be for sale at wholesale.

17. A computer-implemented method for marketing products as recited in claim 11 wherein said products are used automobiles.

18. A computer-implemented method for marketing products as recited in claim 11 wherein said suppliers include automobile lease companies.

19. A computer-implemented method for marketing products as recited in claim 11 wherein said step of collecting inventory information is performed on a periodic time basis.
